(19) United States
(12) Patent Application Publication
(10) Pub. No.: US 2025/0221458 A1
(43) Pub. Date: Jul. 10, 2025

(54) Heating Apparatus For An Aerosol Generating Device

(71) Applicant: JT International SA, Geneva (CH)

(72) Inventor: Jose Eduardo Garcia Garcia, Grand-Saconnex (CH)

(73) Assignee: JT International SA, Geneva (CH)

(21) Appl. No.: 18/847,911

(22) PCT Filed: Mar. 17, 2023
(86) PCT No.: PCT/EP2023/056884

§ 371 Date: Sep. 17, 2024

(30) Foreign Application Priority Data
Mar. 17, 2022 (EP) 22162828.2

(51) Int. Cl. A24F 40/465; A24F 40/20; H05B 3/46

(52) U.S. Cl. CPC A24F 40/465; A24F 40/20; H05B 3/46; H05B 2203/013

(57) ABSTRACT

A heating apparatus for an aerosol generating device is disclosed. The heating apparatus includes: a first tube having an electrically conductive material and having an opening through which an aerosol forming substance can be received; a second tube having an electrically conductive material and arranged radially outwardly with respect to the first tube; at least one electrical insulator component arranged to space the first tube apart from the second tube; and a heater provided on an outer surface of the first tube. The heater is electrically connected to the first tube and the second tube. The heater is configured to provide heat to the received aerosol forming substance by thermal conduction.

### FIELD OF THE INVENTION

The present invention relates to a heating apparatus for an aerosol generating device and an aerosol generating device comprising a heating apparatus. The disclosure is particularly applicable to a portable aerosol generating device, which may be self-contained. In particular, the invention relates to an aerosol generating device with a heater disposed within a vacuum or insulator chamber.

### BACKGROUND

It is a developing field of interest to produce electronic cigarettes that heat, but do not burn, a solid or semi-solid aerosol forming substrate which comprises tobacco. These devices typically receive a rod of tobacco in a heating chamber. The rod is heated to release aerosol which can be inhaled by a user. One issue in these devices is that the heater which supplies heat to the heating chamber can also undesirably heat the remainder of the device. In compact devices this can be disadvantageous because the temperature of the outer surfaces of the device, which are held by a user, can become unacceptably high. In order to mitigate these effects some aerosol generating devices have been provided with vacuum chambers that can space the heater from the outer surfaces. This can provide thermal separation between the heating chamber and the outer surfaces which are held by a user.

Within such aerosol generating devices, it is desirable to improve the efficiency of the heating operation such that the battery life of the device may be extended. To this end, vacuum insulators have been implemented within aerosol generating devices in order to thermally insulate the cavity in which an aerosol substrate is heated, thereby limiting thermal losses to the external environment.

An object of the present invention is to further improve the heating efficiency and reduce undesired heat loss.

### SUMMARY OF INVENTION

According to an aspect of the invention, there is provided a heating apparatus for an aerosol generating device, comprising: a first tube comprising an electrically conductive material and having an opening through which an aerosol forming substance can be received; a second tube comprising an electrically conductive material and arranged radially outwardly with respect to the first tube; at least one electrical insulator component arranged to space the first tube apart from the second tube; and a heater provided on an outer surface of the first tube, wherein the heater is electrically connected to the first tube and the second tube, and wherein the heater is configured to provide heat to the received aerosol forming substance by thermal conduction.

In this way, the first and second tubes can be used as electrical connectors for the heater whilst providing an insulation or insulating space between the two tubes. The first and second tubes essentially form a dual-walled insulator, where the first and second tubes are the two respective walls between which an insulating space is provided. The insulation/insulating space ensures that heat generated by the heater can be used effectively to heat an aerosol generating substance received in the heating apparatus. The electrical insulator component between the two tubes prevents an electrical current from passing directly between the first and second tubes, and may also enclose the space between the first and second tubes.

As will be appreciated, the first tube and the second tube may be made of or comprise a metallic material or other electrically conductive material that will be apparent to the skilled person. Similarly the at least one electrical insulator component comprises a material that ensures electrical insulation between the first and second tubes as well as maintaining the integrity of the space between the two tubes. Advantageously, the present heating apparatus allows a heater to be positioned within an insulation space between the two tubes while providing a convenient mechanism for supplying electrical energy to the heater within a very small space.

Preferably, a vacuum is enclosed between the first tube and the second tube, or an insulating material is provided between the first tube and the second tube. Preferably, the heater is provided within the vacuum. In this way, the space (or insulating space) between the first and second tubes can effectively prevent heat transfer away from the heating area within the first tube (i.e. in which an aerosol forming substance is received and heated). Examples of insulating materials which can be provided between the first and second tubes include, but are not limited to: air, aerogel materials, powders or fibrous insulating materials. It should also be appreciated that if an insulating material is provided between the first and second tubes the space between the first and second tubes may not necessarily be enclosed. For example the at least one electrical insulator component may comprise one or more holes which allow air to flow through the at least one electrical insulator component (i.e. in or out of the insulating space between the first and second tubes).

The design of the at least one electrical insulator component will also be readily apparent to the skilled person. For example, a single insulator component may comprise a length of material having a ring-shaped portion at each end of the length, where each ring-shaped portion spaces apart the first and second tubes at the respective ends of the two tubes, and where the length of material passes around the outside of the second tube. Alternatively, the electrical insulator component may comprise two separate ring-shaped portions which are each plugged into the gap between the first and second tubes.

Preferably, the heater comprises an electrically resistive track that is printed or coated on the first tube. In this way, the heater can effectively transfer heat to an aerosol generating substance received in the first tube by thermal conduction. A printed or coated heater can also ensure a reliable electrical contact with the first tube. Moreover, the ease of manufacturing may be further improved.

Preferably, the first tube and the second tube are electrically connected, respectively, to a power source that can supply electrical power to the heater. Advantageously, the use of the first and second tubes as electrical connectors to a power source improve the ease of manufacturing and allow a reliable electrical connection to be formed between the heater and power source.

Preferably, an inner surface of the first tube is coated with a first electrical insulator layer. Preferably, an outer surface of the second tube is coated with a second electrical insulator layer. Providing electrical insulator layers in or around the first tube and/or second tubes improves the electrical safety of the heating apparatus. Preferably, the at least one electrical insulator component comprises the first and/or second electrical insulator layers for the respective first and second tubes. In this way, the electrical insulator layers can be integrated with the electrical insulator component to simplify manufacturing as well as provide a degree of electrical safety.

Preferably, the at least one electrical insulator component comprises a first ring and a second ring, the first and second rings positioned between the first and second tubes at a first end and a second end of the first and second tubes respectively. For example, the first and second rings may be positioned between the ends of the first and second tubes to enclose a vacuum in the space between the two tubes.

Preferably, the heating apparatus further comprises an abutment positioned within the first tube and configured to limit an insertion of a received aerosol forming substance. Preferably, the abutment comprises a plug. And more preferably, the plug encloses a second vacuum or an insulating material within. Examples of insulating materials which can be provided in the plug include, but are not limited to: air, aerogel materials, powders or fibrous insulating materials.

Providing a second vacuum or an insulating material within the plug improves the heat insulation of the plug such that less heat is lost through the plug piece and more generated heat is transferred into an aerosol generating substance in the first tube. Preferably, the plug comprises an electrical insulator material.

Preferably, the abutment is shaped to allow air to flow through the first tube. In this way, a passage of air can flow through the abutment and the first tube to carry generated aerosol to a user.

According to another aspect of the invention, there is provided an aerosol generating device configured to generate an aerosol for inhalation by a user, the aerosol generating device comprising the heating apparatus according to the first aspect of the invention.

According to another aspect of the invention, there is provided a method of manufacturing the heating apparatus according to the first aspect of the invention, the method comprising the steps of: providing a first tube, the first tube comprising an electrically conductive material and having an opening through which an aerosol forming substance can be received; arranging a heater on an outer surface of the first tube, wherein the heater is configured to provide heat to the received aerosol forming substance by thermal conduction; arranging at least one electrical insulator component on the first tube; arranging a second tube comprising an electrically conductive material on the at least one electrical insulator component such that the second tube is radially outwardly spaced away from the first tube; electrically connecting the heater to the first tube and the second tube.

Preferably, the method further comprises providing a vacuum that is enclosed between the first and second tubes, wherein the heater is provided within the vacuum. Alternatively the method further comprises providing an insulating material between the first tube and the second tube. Examples of insulating materials which can be provided between the first and second tubes include, but are not limited to: air, aerogel materials, powders or fibrous insulating materials.

### BRIEF DESCRIPTION OF DRAWINGS

Embodiments of the invention are now described, by way of example, with reference to the drawings, in which:

FIG. 1 is a perspective view of an aerosol generating device comprising a heating apparatus according to an embodiment of the invention;

FIG. 2 is a cross-sectional schematic view of a heating apparatus according to an embodiment of the invention; and

FIG. 3 is a cross-sectional schematic view of a heating apparatus according to another embodiment of the invention.

### DETAILED DESCRIPTION

As described herein, a vapour is generally understood to refer to a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

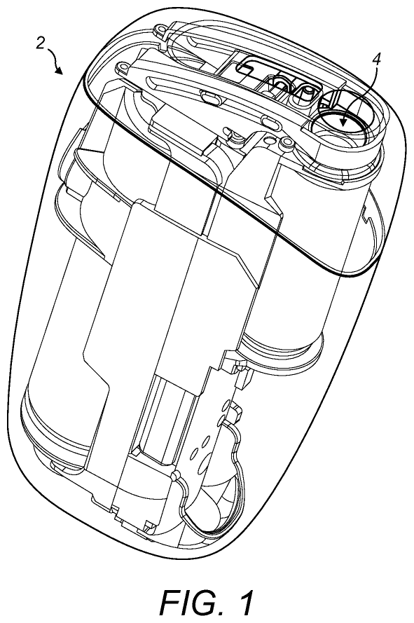

FIG. 1 illustrates an aerosol generating device 2 according to an embodiment of the invention. The aerosol generating device 2 is illustrated in an assembled configuration with exemplary internal components visible. The aerosol generating device 2 is a heat-not-burn device, which may also be referred to as a tobacco-vapour device, and comprises a heating apparatus 4 configured to receive an aerosol substrate such as a rod of aerosol generating material, e.g. tobacco. The aerosol generating device 2 may comprise a power source such as a battery and control circuitry for controlling the supply of power from the power source to the heating apparatus 4. The heating apparatus 4 is operable to heat, but not burn, the rod of aerosol generating material to produce a vapour or aerosol for inhalation by a user. Of course, the skilled person will appreciate that the aerosol generating device 2 depicted in FIG. 1 is simply an exemplary aerosol generating device according to the invention. Other types and configurations of tobacco-vapour products, vaporisers, or electronic cigarettes may also be used as the aerosol generating device according to the invention.

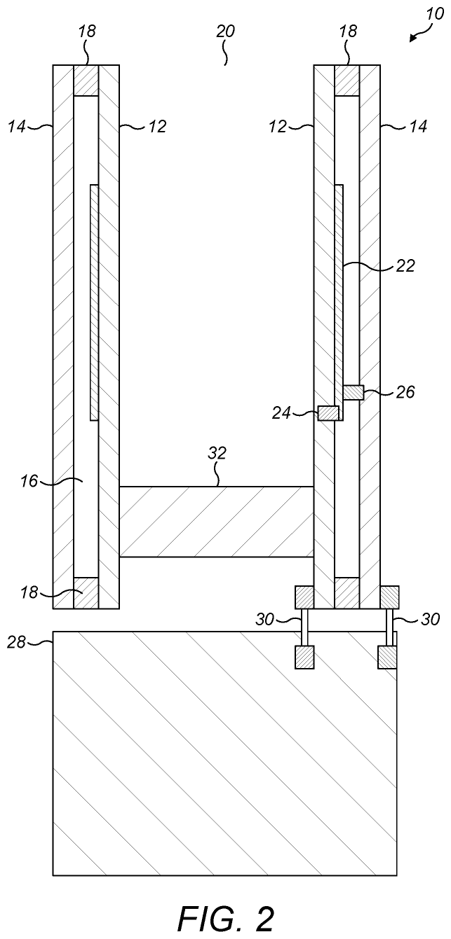

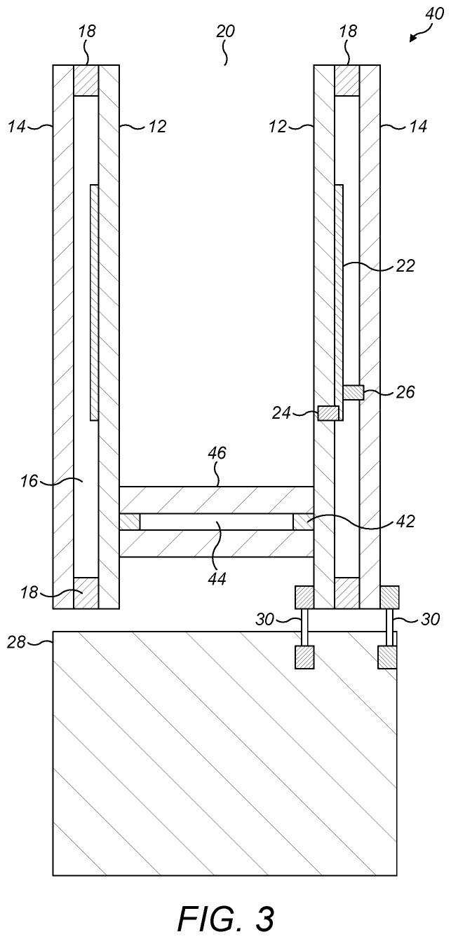

The specific examples below in reference to FIGS. 2 and 3 have been described with a vacuum enclosed between the inner and outer tubes of the heating apparatus. However, it will be appreciated that the vacuum may be replaced with other insulating mediums/materials, such as air, aerogel materials, powders or fibrous insulating materials which may be provided between the inner and outer tubes of the heating apparatus. In such examples (where a vacuum is replaced with an insulating material), the space between the inner and outer tubes may not be enclosed and may allow airflow in and out of the space.

FIG. 2 shows a schematic view of a heating apparatus 10 having an inner tube 12 and an outer tube 14 between which a vacuum 16 is enclosed. The skilled person will understand that the term “vacuum” refers to a space in which the pressure is considerably lower than atmospheric pressure due to the removal of free matter, in particular air. The quality of the vacuum formed between the inner tube 12 and the outer tube 14 may be a low vacuum, a medium vacuum, or a high vacuum.

The inner tube 12 is positioned radially within the inner surface of the outer tube 14 as concentric cylinders such that if viewed from above or below, i.e. parallel to a longitudinal axis of the inner and outer tubes will show the tubes as concentric circles (not shown). In alternative examples, the inner tube and/or outer tube may be formed in other types of cross-sectional shape, such as a square or polygonal.

One or more electrical insulation components 18 are provided between the outer surface of the inner tube 12 and the inner surface of the outer tube 14 at each end of the inner and outer tubes to couple the inner tube 12 and the outer tube 14 together. The electrical insulation component 18 may be a push-fit plug into the space between the inner and outer tubes and extends into the lengths of the inner and outer tubes to a predetermined depth. The one or more electrical insulation components 18 may comprise glass as an electrically insulating material, which can be bonded to the inner and outer tubes. As is explained further below, the inner and outer tubes may comprise a metallic material. In another example, the electrical insulation component(s) 18 may comprise a temperature resistant plastic, such as PEEK (polyetheretherketone). It should be understood that the electrical insulation component 18 fixes the position of the inner tube 12 relative to the outer tube 14, and maintains the vacuum 16 enclosed between the inner tube 12, outer tube 14 and electrical insulation component(s) 18.

The inner tube 12 is hollow and defines an opening 20 through which an aerosol forming consumable or substance (not shown) can be received in the inner tube 12. In other words, the inner tube 12 provides a tunnel through which an aerosol forming substance can pass, being supported by the inner surface of the inner tube 12. The opening 20 acts as the access point for insertion of a consumable into the heating apparatus 10 in its constructed form.

A heater 22 is provided on the outer surface of the inner tube 12. The heater 22 is an electrically resistive track that may be printed or coated on the inner tube 12. Alternatively, the heater 22 may be layered on the inner tube 12. A first electrical connection 24 connects the heater 22 with the inner tube 12, and a second electrical connection 26 connects the heater 22 with the inner surface of the outer tube 14, such that the inner tube 12, the first electrical connection 24, the heater 22, the second electrical connection 26 and the outer tube 14 form an electrical circuit with a power source or a printed circuit board assembly (PCBA) 28 when the inner and outer tubes are electrically connected to the PCBA 28. This construction advantageously facilitates the production of the unit because electrical connections can be provided easily via the inner tube 12 and the outer tube 14, which eliminates the need for wiring that could conduct heat away from the heater and which might affect the integrity of the vacuum 16.

Further electrical connections 30 are included to connect the inner tube 12 and the outer tube 14 to the PCBA 28 or power source, as will be apparent to the skilled person. As will be appreciated, the inner tube 12 and the outer tube 14 are each made of, or at least comprise, an electrically conductive material, e.g. a metallic material such as stainless steel to allow an electrical current to pass through to and from the heater 22. The inner surface of the inner tube 12 and/or the outer surface of the outer tube 14 may be coated with an electrically insulating layer (not shown) for safety.

The heating apparatus 10 further includes a plug 32 arranged within the inner tube 12 toward the opposite end of the inner tube 12 from the opening 20. The plug 32 provides a surface against which an inserted consumable may abut, thereby limiting the depth of insertion of the consumable. In other words, the plug 32 defines a length of a consumable cavity in the inner tube 12.

The plug 32 comprises an insulating material, such as PEEK material (polyetheretherketone), or PEEK and an aerogel material, which prevents thermal conduction through the plug 32 such that heat loss from the inner tube 12 and/or a received consumable is not lost through the plug 32. The insulating material may comprise aerogel or superwool sheets, or may be an insulation coating. The plug 32 may also act as an electrical insulator.

The plug 32 may also comprise one or more apertures or holes (not shown) which allow air to flow through the inner tube 12, and carry any generated aerosol from an inserted consumable to a user on inhalation by the user. For example, the plug 32 may be shaped as a ring.

The cross-sectional schematic of the heating apparatus 40 shown in FIG. 3 is largely the same the heating apparatus 10 of FIG. 2, except that the plug 42 in heating apparatus 30 of FIG. 3 is a vacuum component that does not conduct electrical energy.

As shown in FIG. 3, the plug 42 is hollow. The plug 42 comprises an outer casing 46 that encloses a vacuum 44 within the hollow interior. The outer casing 46 can be made of an insulating material, such as PEEK, or may be made of a metallic material such as stainless steel that is coated to provide electrical and thermal insulation. The plug 42 can limit the depth of insertion of a tobacco rod, and can minimise any escape of heat from the lower end of the heating chamber. The use of a vacuum 44 within the plug 42 can further enhance the thermal insulation effects of the plug, which means that more of the generated heat can be used to generate an aerosol, which advantageously improves the efficiency of the device.

1. A heating apparatus for an aerosol generating device, comprising:
a first tube comprising an electrically conductive material and having an opening through which an aerosol forming substance can be received;
a second tube comprising an electrically conductive material and arranged radially outwardly with respect to the first tube;
at least one electrical insulator component arranged to space the first tube apart from the second tube; and
a heater provided on an outer surface of the first tube, wherein the heater is electrically connected to the first tube and the second tube, and wherein the heater is configured to provide heat to the received aerosol forming substance by thermal conduction.

2. The heating apparatus of claim 1, wherein a vacuum is enclosed between the first tube and the second tube, or wherein an insulating material is provided between the first tube and the second tube.

3. The heating apparatus of claim 1, wherein the heater comprises an electrically resistive track printed or coated on the first tube.

4. The heating apparatus of claim 1, wherein the first tube and the second tube are electrically connected, respectively, to a power source configured to supply electrical power to the heater.

5. The heating apparatus of claim 1, wherein an inner surface of the first tube is coated with a first electrical insulator layer.

6. The heating apparatus of claim 1, wherein an outer surface of the second tube is coated with a second electrical insulator layer.

7. The heating apparatus of claim 5, wherein the at least one electrical insulator component comprises the first and/or second electrical insulator layers for the respective first and second tubes.

8. The heating apparatus of claim 1, wherein the at least one electrical insulator component comprises a first ring and a second ring, the first and second rings positioned between the first and second tubes at a first end and a second end of the first and second tubes respectively.

9. The heating apparatus of claim 1, further comprising an abutment positioned within the first tube and configured to limit an insertion of a received aerosol forming substance.

10. The heating apparatus of claim 9, wherein the abutment comprises a plug.

11. The heating apparatus of claim 10, wherein the plug encloses a second vacuum or an insulating material within.

12. The heating apparatus of claim 9, wherein the plug comprises an electrical insulator material.

13. The heating apparatus of claim 9, wherein the abutment is shaped to allow air to flow through the first tube.

14. An aerosol generating device configured to generate an aerosol for inhalation by a user, the aerosol generating device comprising the heating apparatus according to claim 1.

15. A method of manufacturing the heating apparatus of claim 1, the method comprising the steps of:
providing a first tube, the first tube comprising an electrically conductive material and having an opening through which an aerosol forming substance can be received;
arranging a heater on an outer surface of the first tube, wherein the heater is configured to provide heat to the received aerosol forming substance by thermal conduction;
arranging at least one electrical insulator component on the first tube;
arranging a second tube comprising an electrically conductive material on the at least one electrical insulator component such that the second tube is radially outwardly spaced away from the first tube; and
electrically connecting the heater to the first tube and the second tube.
